(19) United States
(12) Patent Application Publication
(10) Pub. No.: US 2026/0266163 A1
(43) Pub. Date: Sep. 10, 2026

(54) PIGGING, A MANIFOLD VALVE BLOCK AND FLUID FLOW CONTROL

(71) Applicant: BAKER HUGHES ENERGY TECHNOLOGY UK LIMITED, Bristol (GB)

(72) Inventors: José Felipe FREIRE MACHADO, Florence Firenze (IT); Mohammed Hasan ALI, Hovik Akershus (NO); Caterina GALLI, Florence Firenze (IT)

(21) Appl. No.: 18/869,475

(22) PCT Filed: May 31, 2023
(86) PCT No.: PCT/EP2023/025259

§ 371 Date: Nov. 26, 2024

(30) Foreign Application Priority Data
Jun. 1, 2022 (GB) 2208101.2

(51) Int. Cl. E21B 41/00; E21B 34/04

(52) U.S. Cl. CPC F16L 41/03; E21B 41/0007; E21B 43/0175; F16L 41/02; F16L 2101/00

(57) ABSTRACT

A rigid valve block body, its method of manufacture, a method of pigging a valve block and/or branches and a method for determining fluid flow direction are disclosed. The valve block body includes a first fluid inlet and a further fluid inlet at opposed sides of a rigid valve block body. A first fluid outlet of the valve block body and a further fluid outlet of the valve block body are disposed in a spaced apart relationship. A first V-shaped fluid com-munication passageway comprises two passageway portions each extending within the valve block body from a first common root region proximate to the first fluid inlet. A further V-shaped fluid communication passageway com-prises two further passageway portions each extending within the valve block body away from a further common root region proximate to the further fluid port.

The present invention relates to a valve block body, a subsea structure such as a manifold, a method for determining fluid flow direction at such a subsea structure and a method of pigging well branches. In particular, but not exclusively, the present invention relates to a rigid valve block body in which internal bores are formed to provide respective fluid communication passageways and passageway portions. The body includes two V-shaped fluid communication passageways and a through passage between opposed inlets that helps facilitate a pigging operation of the valve block and one or more branch lines connected to the valve block.

Various subsea structures are known where fluid inlets are connected to pipes (which may be rigid or flexible) to receive fluid and whereby incoming fluid from such fluid inlets needs to be routed in a particular direction according to use to one or maybe more of multiple possible fluid outlets. An example of a subsea structure is a subsea manifold. A subsea manifold is thus an example of a subsea structure. A subsea manifold can be used to connect flowlines and subsea Christmas trees as part of a subsea layout to help optimise and reduce a number of risers needed to provide a fluid flow path to a surface platform. The surface platform may be a floating or fixed platform. Conventionally there are several types of manifold which are known. One particular example is a manifold required for a cluster or drill centre subsea layout. Conventionally such a manifold would have dual flowlines and manifold headers and would have an ability to allow pigging operations through the system.

Manifolds are historically designed and fabricated to the bespoke requirements of a particular application. This requires significant repeat engineering effort and results in long lead times due to a necessity to source components from a number of different sub-suppliers. On many projects manifold headers are sized to meet pipeline internal bore requirements and often require the headers to be pigged to maintain the bores in a satisfactory and fully functioning condition. The size and bore of such headers is often driven by project pipeline requirements and can be dictated conventionally by a selected pipeline design. As a result it is difficult to pre-engineer headers in advance of a project so that a supplier can only propose their standard configurations to an end user.

It has been suggested to incorporate headers into a block of material. Whilst in practice this provides some advantages it can significantly add cost and weight to a manifold. This is particularly the case if consideration is given to a minimum bend requirement imposed by any pigging requirements. Consideration also has to be given to any specific header valve selection criterion including valve size, pressure rating, application design codes and sub-suppliers' design features which would dictate a design and final configuration of such headers. As a result the need to address such requirements can significantly add to engineering activities of any particular project.

Another problem associated with certain conventional manifold designs and structures is that for some designs significant numbers of weld points are required to connect various inlets and outlets together in hand with any headers. This can be a time consuming and thus costly process and the weld points can lead to failure points in use.

Certain conventional manifolds require many outlets and lack versatility in selectively connecting multiple inputs to those possible outlets.

Certain conventional manifold structures and valve blocks used in such structures suffer from the problem that they can physically be significantly heavy items which makes them difficult to manoeuvre to a desired location and then lower to a seabed location.

Certain manifold valve block bodies, pipes and piping connected to a valve block body and Christmas trees and jumpers connected to the manifold suffer from the problem that overtime fluid flow passages can become fully or partially blocked by a build-up of undesirable substances. For example hydrates can form under conditions of low temperature and high pressure which are often customary in an environment of subsea oil transmission lines. Removing hydrates or other build-up material is a constant problem. A variety of methods are known in the art directed to cleaning and unblocking partially or fully blocked fluid communication passageways. The use of cleaning pigs is an often used technology. In a pigging mode of operation a pig which is a device generally made of elastomeric material with a high strain capacity or other material such as metals is passed through a fluid communication passageway. It is known that a pig often has a cylindrical or spherical shape or can utilise several discs connected by a metal or plastic shaft. Cleaning is carried out in a pigging mode of operation whereby a pressure is applied to one side of the pig by means of a gas or liquid pushing it along a desired route in a valve block body or other rigid or flexible pipework.

It is known that according to certain designs the route a pig follows in a pigging mode of operation can be uncontrolled to a full or partial extent. That is to say on occasion a pig can be directed along a route which is undesirable. A pig can get stuck at a particular location causing a blockage which is difficult and sometimes impossible to remove. For some types of piping or pipe work or manifold blocks pig excluders in the form of blocking structures such as bars can be welded in place to prevent a pig from accidentally passing down a passageway that is not desired. However in machined block manifolds where a single valve block is formed by boring holes in a solid block such blocking elements are difficult/impossible to install since the manifold valve block structure is formed generally by a process in which fluid flow passageways are perforated (i.e. machined) or bored through a solid body.

Certain valve block bodies are already in use and these are difficult to pig out. This means that a whole manifold valve block body must be replaced to make a piggable valve block body. The replacement of such an element is costly and difficult to achieve.

It is an aim of the present invention to at least partly mitigate one or more of the above-mentioned problems.

It is an aim of certain embodiments of the present invention to provide a manifold valve block that is piggable.

It is an aim of certain embodiments of the present invention to provide a method for pigging a manifold valve block and optionally branch lines and Christmas Trees connected to the valve block.

It is an aim of certain embodiments of the present invention to provide apparatus and/or a method whereby a pig, used to pig through one or more passages in a manifold valve block and piping and connected equipment such as a subsea Christmas Tree, is prevented from accidentally routing down an undesired passageway or getting stuck at a passageway junction point.

It is an aim of certain embodiments of the present invention to provide an insert, locatable at a root region in a manifold valve block, that includes one or more pig excluder elements that help enable a desired fluid flow between passages but which prevent a pig, used to pig out a bore in a manifold valve block, from fully or at least partially travelling along an undesired fluid communication passageway or passageway portion.

It is an aim of certain embodiments of the present invention to provide a manifold valve block and a method for manufacturing a manifold valve block in which fluid communication passageways are formed as bores through the material of the valve block body and the bores are manufactured so as to avoid any need for additional elements, such as a pigging insert, to be used to prevent undesired rooting of a pig during a pigging process of the manifold valve block.

It is an aim of certain embodiments of the present invention to provide a compact and modular manifold scheme using modular block branch assemblies which can be used to control and/or condition and/or distribute flow of fluids to/from subsea Christmas Trees to a host facility via one or more of dedicated headers and flowlines.

It is an aim of certain embodiments of the present invention to enable branch lines connected to a Manifold block to be pigged and optionally to enable Christmas Trees connected to those branch lines to be pigged.

It is an aim of certain embodiments of the present invention to provide a method of providing a piggable manifold valve block that includes needed fluid communication passageways or passageway portions together with pig excluding functionality.

It is an aim of certain embodiments of the present invention to provide a valve block body in the form of a rigid body which includes fluid inlets and fluid outlets and internal fluid communication passageways.

It is an aim of certain embodiments of the present invention to provide a method for determining fluid flow direction at a subsea structure.

It is an aim of certain embodiments of the present invention to provide a subsea structure for selectively connecting a plurality of inlet fluid flowlines to at least one outlet fluid flowline.

According to a first aspect of the present invention there is provided a rigid valve block body for determining fluid flow direction at a subsea structure, comprising:
a first fluid inlet and a further fluid inlet at opposed end regions of a rigid valve block body;
a first fluid outlet of the valve block body and a further fluid outlet of the valve block body disposed in a spaced apart relationship;
a first V-shaped fluid communication passageway that comprises two passageway portions each extending within the valve block body from a first common root region proximate to the first fluid inlet;
a further V-shaped fluid communication passageway that comprises two further passageway portions each extending within the valve block body away from a further common root region proximate to the further fluid port, wherein an end region of each passageway portion of the first V-shaped fluid communication passageway meets an end region of a respective passageway portion of the further V-shaped fluid communication passageway proximate to a respective fluid outlet of the valve block body; and
an inlet connecting fluid communication passageway that extends between the first common root region and the further common root region.

Aptly an inner bore diameter of each passageway portion is less than a corresponding inner bore diameter of the inlet connecting fluid communication passageway Aptly the inner bore diameter of each passageway portion is less than 70%, and optionally is less than 50% of a corresponding inner bore diameter of the inlet connecting fluid communication passageway.

Aptly the valve block body further comprises at least one insert element, each located at a respective common root region, that comprises a sleeve body having an open mouth at each respective sleeve body end and at least one through hole in a sidewall of the sleeve body.

Aptly the at least one through hole comprises a first plurality of through holes and a further plurality of through holes disposed on diametrically opposed regions of the sleeve body.

Aptly each through hole in each pluarlity of through holes comprises an elongate channel.

Aptly each elongate channel is configured so that, when viewed from a side at an angle common to an offset angle between each passageway portion and the inlet connecting fluid communication passageway, an outline edge region of each channel falls on an imaginary circle.

Aptly each through hole in each plurality of through holes comprises a round aperture.

Aptly each plurality of through holes comprises one, two or three small diameter holes disposed between two spaced apart large diameter holes aligned along a common major alignment axis and two further larger diameter holes each aligned on a centre point associated with the small diameter holes and perpendicular to and on respective opposed sides of the common major alignment axis.

Aptly each plurality of through holes comprises at least one further pair of small diameter holes each small hole in a further pair of small diameter holes being aligned on a respective side of a respective further large diameter hole along a minor alignment axis that is spaced apart from and substantially parallel with the major alignment axis.

Aptly each small diameter hole is a round hole having a diameter of between around 50 mm and 90 mm and each large diameter hole is a round hole that has a diameter of between around 100 mm and 200 mm, and optionally a diameter of each large hole is less than 25% of the circumference of the sleeve body.

Aptly a respective selection valve chamber, in a fluid flow path in each passageway portion, for a respective flow selection valve and/or a respective isolation valve chamber, for a respective pig path isolation valve, in the inlet connecting fluid communication passageway.

Aptly the valve block body further comprises a still further fluid outlet in a base region of the valve block body.

Aptly the valve block body comprises at least one arm region, that each extend from a side of the block body, and that comprises an inlet passageway portion that extends through the arm region from an opening orifice on the respective side.

Aptly the valve block body further comprises a respective isolation valve chamber, in a fluid flow path in each inlet passageway portion in each arm region, for a respective well isolation valve.

Aptly the valve block body further comprises a first intervention port and a further intervention port each extending from a respective opening orifice in an outer surface of the valve block body to a respective inlet passageway portion of a respective arm region via an intervention valve chamber, for a respective intervention valve.

Aptly the valve block body comprises at least one opening orifice on each respective side of the block body, each opening orifice comprising a respective fluid inlet of the valve block body, and a plurality of securing elements on the side around the opening orifice for securing to a respective inlet connection block that comprises an inlet passageway portion.

Aptly the valve block body further comprises a respective isolation valve chamber, in a fluid flow path in each inlet passageway portion in each inlet connection block, for a respective well isolation valve.

Aptly the end regions of each passageway portion meet and open into corresponding end regions of other passageway portions at an exit chamber region in the valve block body and each exit chamber region is proximate to a respective fluid outlet.

Aptly the valve block body comprises two fluid inlets and two fluid outlets.

Aptly the valve block body is a forged metallic body and optionally any bend in each flow path through the body is more than 120° and less than 170° inclined with respect to an incoming fluid flow path axis.

According to a second aspect of the present invention there is provided a subsea structure for connecting a plurality of inlet fluid flow lines to at least one outlet fluid flow line, comprising:
a valve block body as defined according to the first aspect of the present invention;
a plurality of flow selection valves each at least partially located in a respective selection valve chamber of the valve block body;
a plurality of well isolation valves each at least partially in a respective isolation chamber of the valve block body; and
a pig path isolation valve at least partially located in a respective pig path isolation chamber.

Aptly the subsea structure further comprises a plurality of inlet connection blocks secured over respective fluid inlets of the valve block body, each comprising a respective isolation valve chamber, and an isolation valve at least partially in an isolation valve chamber.

Aptly the subsea structure is a subsea manifold.

Aptly the subsea structure comprises a plurality of headers external to the valve block body and in selective fluid communication with the first and further fluid outlets.

According to a third aspect of the present invention there is provided a method for determining fluid flow direction at a subsea structure, comprising the steps of:
providing an incoming flow of fluid to at least one fluid inlet of a plurality of fluid inlets of a valve block body; and
selecting a state of a respective isolation valve in a flow path of each of two respective passageway portions, of at least one V-shaped fluid communication passageway of at least two V-shaped fluid communication passageways in the valve block body; and
selecting a closed state of a pig path isolation valve to prevent fluid flow along an inlet connecting fluid communication passageway between a first and further fluid inlet of the valve block body; thereby
directing the incoming flow of fluid from the at least one fluid inlet to a selected one fluid outlet of the valve block body.

Aptly the method comprises simultaneously providing an incoming flow of fluid at a plurality of the fluid inlets; and via a selected state of the isolation valves in the V-shaped fluid communication passageways, and with the pig path isolation valve in a closed state, routing the incoming flow along a plurality of passageway portions to a common outlet thereby mingling fluid from a plurality of sources or to separate fluid outlets thereby keeping fluid from a plurality of sources separate as the fluid flows through the valve block body.

Aptly the method further comprises providing fluid to a plurality of headers that are external to the valve block body by routing fluid from flow lines to the headers via at least one valve block body.

According to a fourth aspect of the present invention there is provided a method of providing a rigid valve block body, comprising the steps of:
providing a valve block body blank;
providing a first lumen through the blank from a first fluid inlet at a first blank end to a further fluid inlet at a further blank end;
providing a second lumen and a third lumen as respective passageway portions from a first fluid outlet on a first blank side to a respective one of a first common root region and a further common root region in fluid communication with the first lumen; and
providing a fourth lumen and a fifth lumen, as respective passageway portions, from a further fluid outlet on a further blank side to a respective one of the first common root region and the further common root region.

Aptly the method comprises providing the first lumen, as an inlet connecting fluid communication passageway, with an inner bore diameter that is greater than a corresponding innerbore diameter of each passageway portion and optionally providing the first lumen as a straight through bore in the blank or as a throughbore that is curved with a radius of curvature greater than 2 m.

Aptly the method comprises providing at least one insert element that comprises a sleeve body associated with a longitudanal sleeve access, at a respective common root region;
aligning a respective open mouth at each respective sleeve body end with a primary axis of the first lumen; and
aligning at least one through hole in a sidewall of the sleeve body with a flow axis associated with a respective passageway portion.

According to a fifth aspect of the present invention there is provided a method of pigging a manifold valve block body, comprising:
providing a pig device at a first fluid inlet of a first and a further fluid inlet disposed at opposed end regions of a valve block body that comprises a first V-shaped fluid communication passageway that comprises two passageway portions each extending within the valve block body from a first common root region proximate to the first fluid inlet, and a further V-shaped fluid communication shaped passageway that comprises two further passageway portions each extending within the valve block body away from a further common root region proximate to a further fluid inlet;
urging the pig device from the first fluid inlet to a remaining fluid inlet via an inlet connecting fluid communication passageway that extends between the first common root region and the further common root region.

Aptly the method further comprises preventing the pig device from deviating from a path aligned with the inlet connecting fluid communication passageway.

Aptly the method further comprises preventing the pig device from deviating by providing the passageway portions as bores in the valve block body that have an inner bore diameter less than an inner bore diameter of the inlet connecting fluid communicating passageway.

Aptly the method further comprises preventing the pig device from deviating via at least pig blocking member of at least one insert element provided at a respective common root region in the valve block body.

Aptly the method further comprises providing fluid communication between a common root region and a passageway portion that extends from the common root region, via a plurality of through holes in a sleeve body of the insert element; and preventing passage of the pig device along said a passageway portion via a portion of the sleeve body disposed between adjacent through holes.

Certain embodiments of the present invention provide a valve block body which includes internal fluid communication passageways that can be used to connect multiple fluid inlets with one or more selected fluid outlets according to desire. This enables a fluid flow direction to be determined at a subsea structure that includes the valve block body.

Certain embodiments of the present invention provide a valve block body which enables inlets for the block body to be pigged during a pigging mode of operation.

Certain embodiments of the present invention provide a valve block body and a method of manufacturing a valve block body which enables a fluid flow direction to be determined at a subsea structure and which can be pigged.

Certain embodiments of the present invention provide a valve block body in which bores used to define fluid communication passageways in the block body have a diameter selected so as to help prevent accidental passage of a pig, during a pigging mode of operation, through the block body in an undesired direction.

Certain embodiments of the present invention provide an insert and a method of manufacturing an insert which can be located within a valve block body and secured at a desired site and that enables desired fluid flow between fluid communication passageways but prevents movement of a pig, during a pigging mode of operation, down a fluid communication passageway in the block body which is undesired.

Certain embodiments of the present invention provide a valve block body which provides a wide variety of fluid flow path selection and which is piggable between inlets of the valve block body during a pigging mode of operation.

Certain embodiments of the present invention provide a pigging insert which can be located within a valve block body and which includes one or more pig directing elements which enable fluid flow to be selected in a desired direction but which prevents a pig, used in a pigging mode of operation, from accidentally getting stuck or moving partially along an undesired passageway in a valve block body.

Certain embodiments of the present invention provide a subsea structure, such as a manifold or the like, which can be utilised for connecting multiple inlet fluid flowlines to at least one outlet fluid flowline. The connection can be made selectively so that multiple possible pathways are provided that can each be selected according to choice.

Certain embodiments of the present invention provide a subsea manifold which is lighter (in terms of weight) than many conventional manifolds, thereby reducing structure and foundation requirements. This makes transportation and positioning of the manifold at a desired subsea location more convenient than is possible with conventional techniques.

Certain embodiments of the present invention utilise a modular approach to the design and manufacture of subsea manifolds or other such subsea structures. By utilising multiple valve blocks and associated valves of a given/pre-set configuration rather than a bespoke valve block or bespoke valve blocks for a specific use, a cost associated with the provision of manifolds can be much reduced relative to some conventional solutions.

Certain embodiments of the present invention provide a cluster/drill centre manifold that can facilitate a direction of fluids flowing from adjacent multiple trees which are connected to the manifold via jumpers. This helps provide the flexibility to co-mingle and/or segregate wells when required. It also allows the re-use of previous exploration wells. It is also possible to accommodate other requirements such as chemical injection, controls, monitoring and/or test equipment systems.

Certain embodiments provide a method of pigging a manifold valve block and optionally branch lines and possibly including subsea Christmas Trees connected to the valve block.

Certain embodiments of the present invention provide a compact and modular manifold using modular block branch assemblies. The repeatability of block designs for manifold assembly including common mounting configurations and repeat fabrication methodologies mean that manifolds can be constructed where desired in a convenient and efficient manner.

Certain embodiments of the present invention provide an additive manufacturing process used to generate a manifold valve block body that can be pigged and which optionally includes one or more pig excluder elements to help avoid a pig getting stuck or incorrectly routed during a pigging mode of operation.

Certain embodiments of the present invention help standardise a number of shared components with Christmas tree systems allowing for bulk sourcing discounts and the feasibility of putting stocking agreements in place. Commonality of parts also helps a customer with a need for a reduced level of spares, storage and maintenance.

Certain embodiments of the present invention thus provide standardised components and sub-assemblies that can be taken “off-the-shelf” to meet any specific requirements of any specific application. Valve blocks can be manufactured, qualified and pressure tested prior to being transported to a region of use where final assembly and installation occur. As a result branch blocks therefore become a sub-component of a cluster manifold allowing a high degree of local content assembly.

Certain embodiments of the present invention provide a retrofittable insert which can be premanufactured and then provided at an existing valve block subsea enabling the valve block body to be updated to include one or more pig blocking structures.

Certain embodiments of the present invention allow in-house manufacturing providing better control and repeatability of valve blocks compared to fabrication by third parties.

Certain embodiments of the present invention allow manifold branch piping & isolation valves to be combined, standardised and packaged into a common standard branch block assembly.

Certain embodiments of the present invention provide standard interfaces for headers and manifold structure.

Certain embodiments of the present invention allow spool fabrication and/or welding to be reduced, thereby simplifying the manifold assembly process.

Certain embodiments of the present invention allow a block assembly to be FAT tested prior to shipment and/or delivery of assembly of the block assembly to the fabrication site.

Certain embodiments of the present invention will now be described hereinafter, by way of example only, with reference to the accompanying drawings in which:

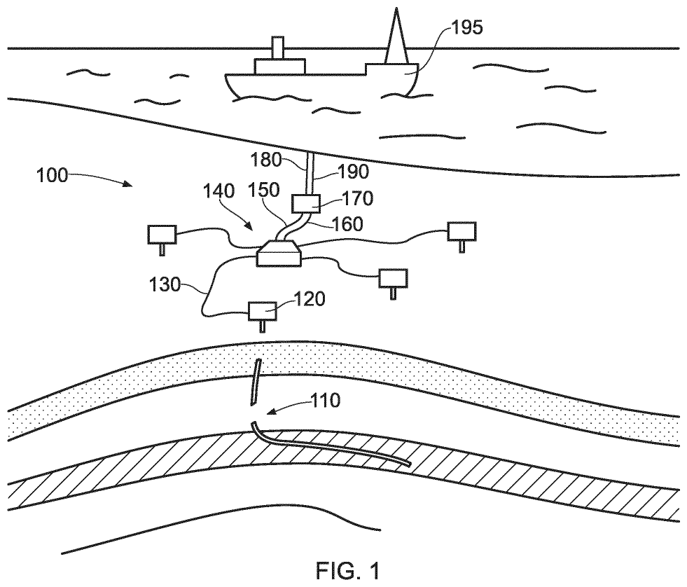

FIG. 1 illustrates a subsea structure, in the form of a compact manifold near a completion and branch lines connecting the manifold to respective subsea Christmas Trees;

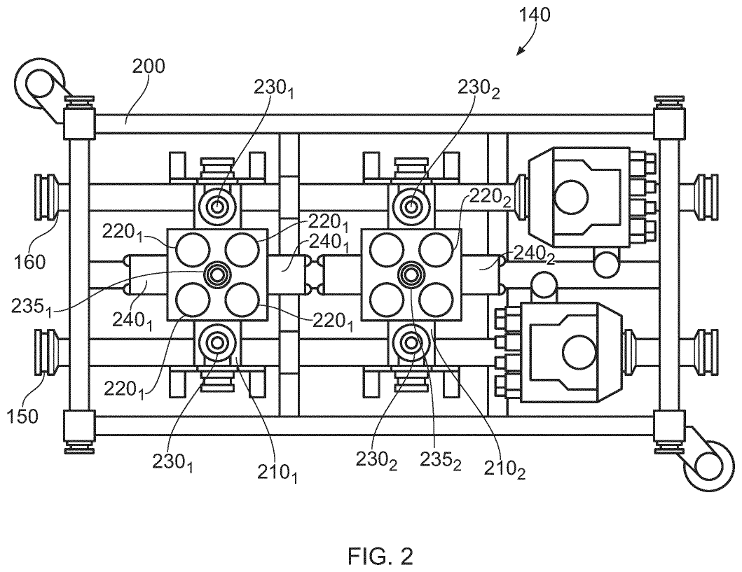

FIG. 2 illustrates a plan view of a manifold including two valve block assemblies each able to receive two inlet flows of fluid from respective branch lines and connection to associated headers;

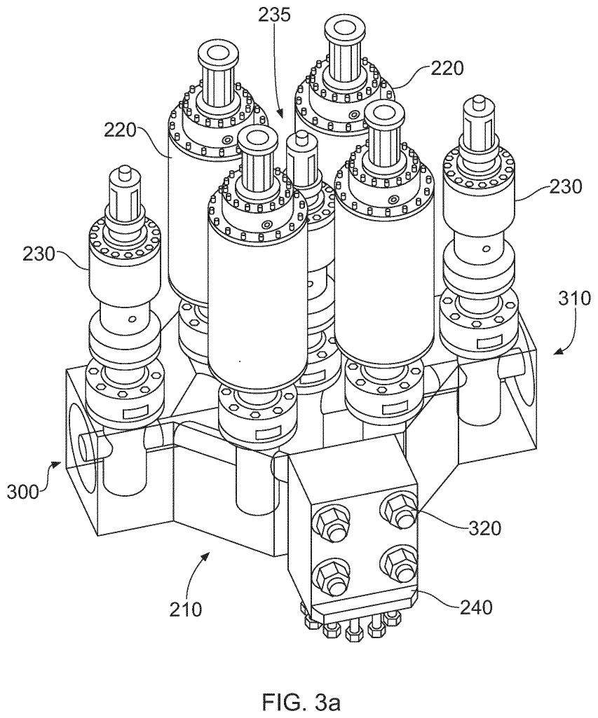

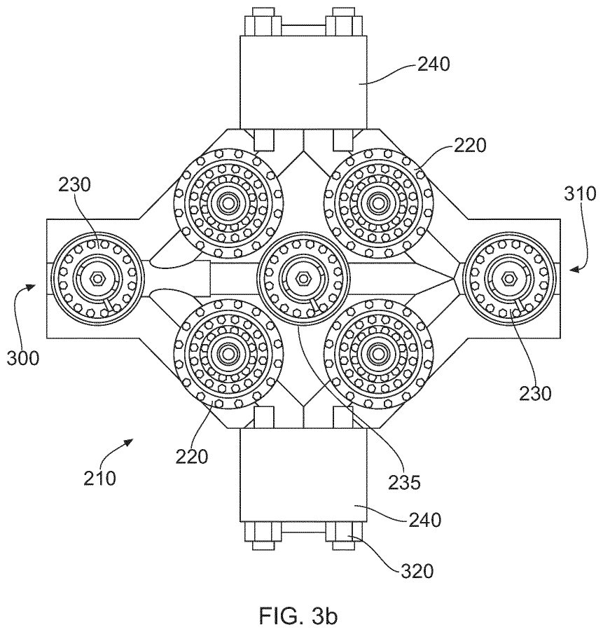

FIG. 3a illustrates a perspective view of one of the two valve blocks and associated valves shown in FIG. 2;

FIG. 3b illustrates a plan view from above of a valve block and associated valves including a pig path isolation valve on a central through passageway;

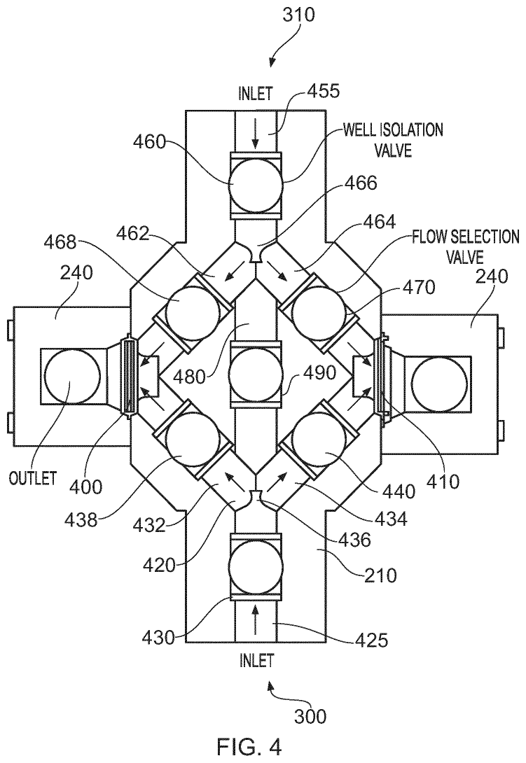

FIG. 4 illustrates fluid communication passageways including a central through bore in a rigid valve block body;

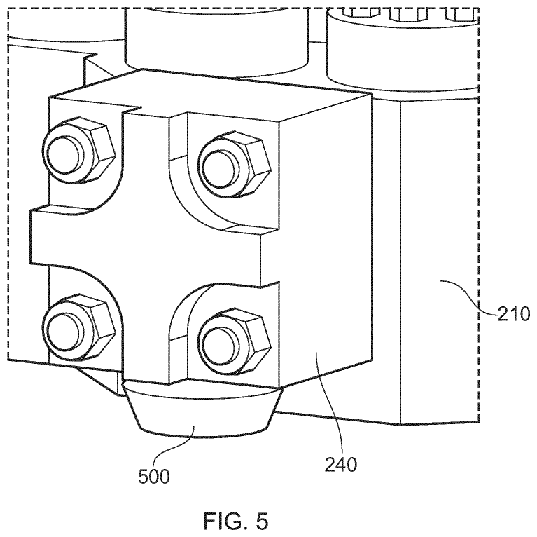

FIG. 5 illustrates a fluid outlet via an outlet block and how a direction of the outlet can be selectively re-orientated;

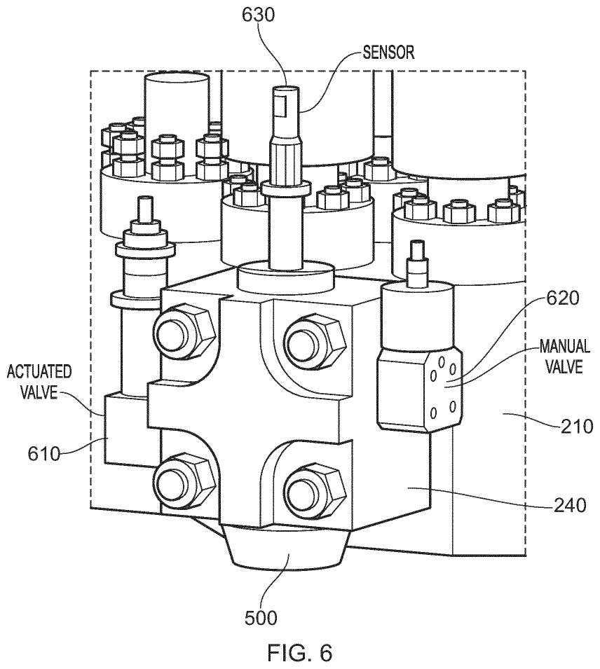

FIG. 6 illustrates a fluid outlet with the addition of optional manual or actuated small bore chemical injection valves and connectors for a pressure and temperature sensor;

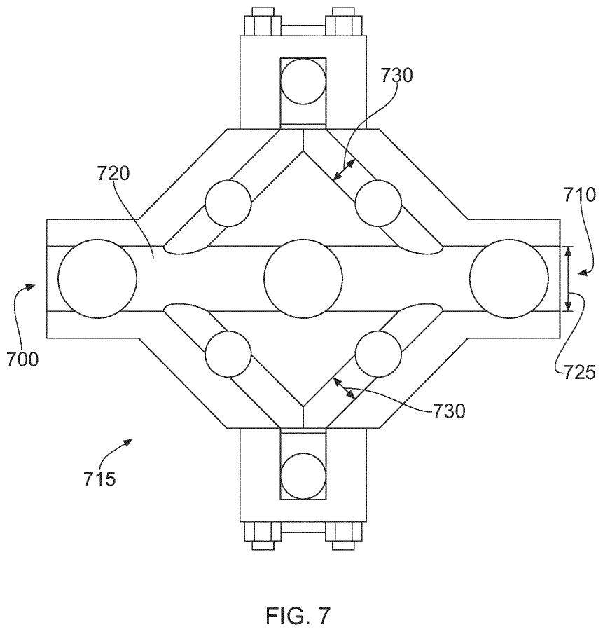

FIG. 7 illustrates how a pig can be blocked by providing bores in a valve block body that have different internal diameters;

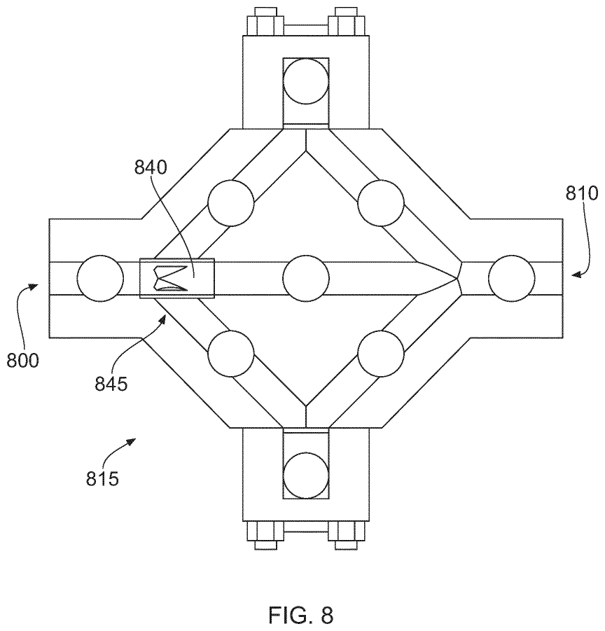

FIG. 8 illustrates a pig insert having the body of a sleeve that is perforated with elongate slots thereby providing pig blocking capability;

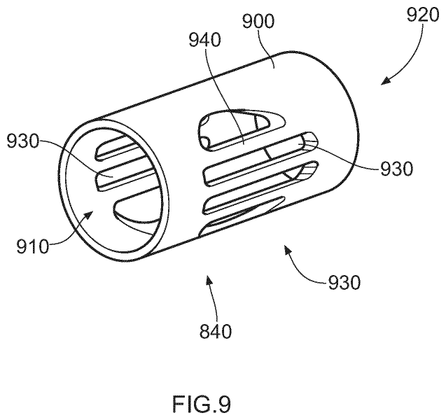

FIG. 9 illustrates slots in a sleeve of an insert;

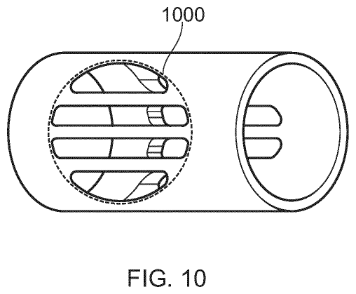

FIG. 10 illustrates ends of slots lying on an imaginary circle when looking from a position aligned with a passageway portion;

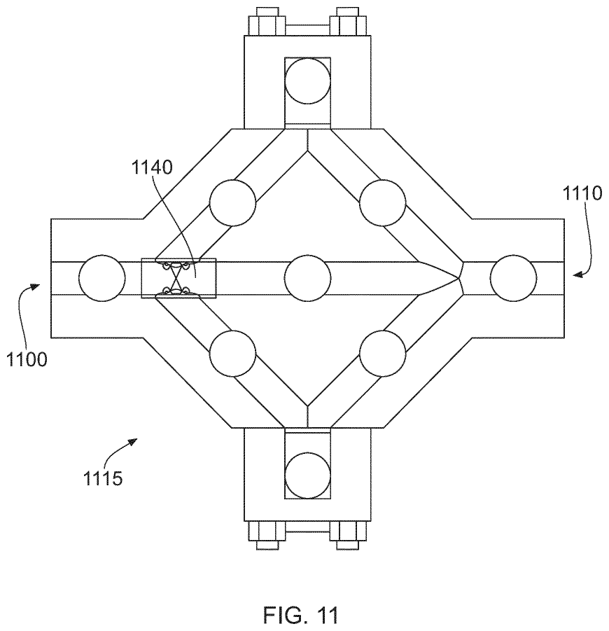

FIG. 11 illustrates an alternative pig blocking insert with fluid communication passageways that block a pig but allow fluid communication;

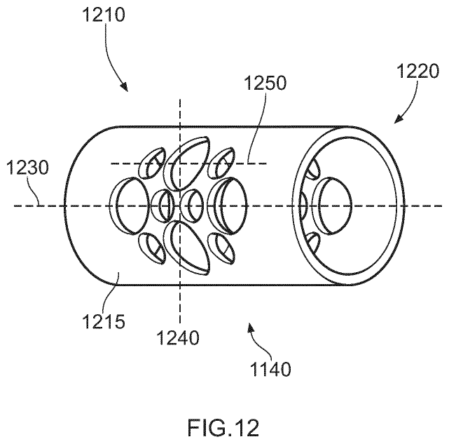

FIG. 12 illustrates diametrically opposed groups of round holes in a sleeve body of an insert;

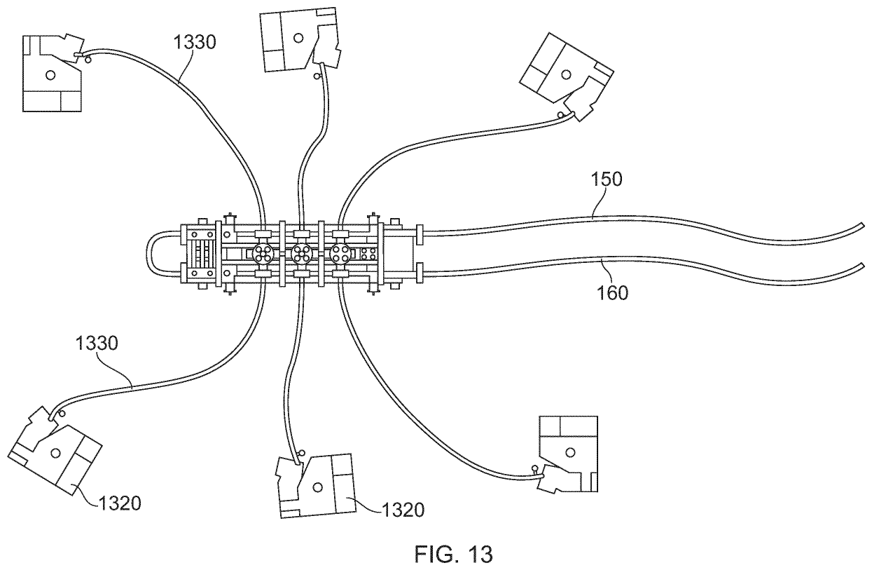

FIG. 13 illustrates subsea Christmas Trees in fluid communication with a manifold and associated Headers;

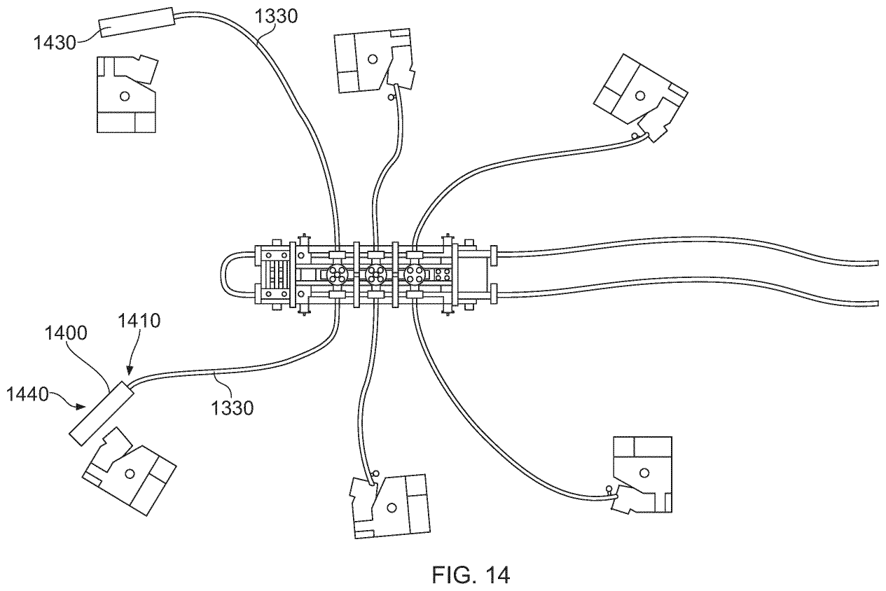

FIG. 14 illustrates a pigging mode of operation in which branch lines and a valve block body are pigged; and

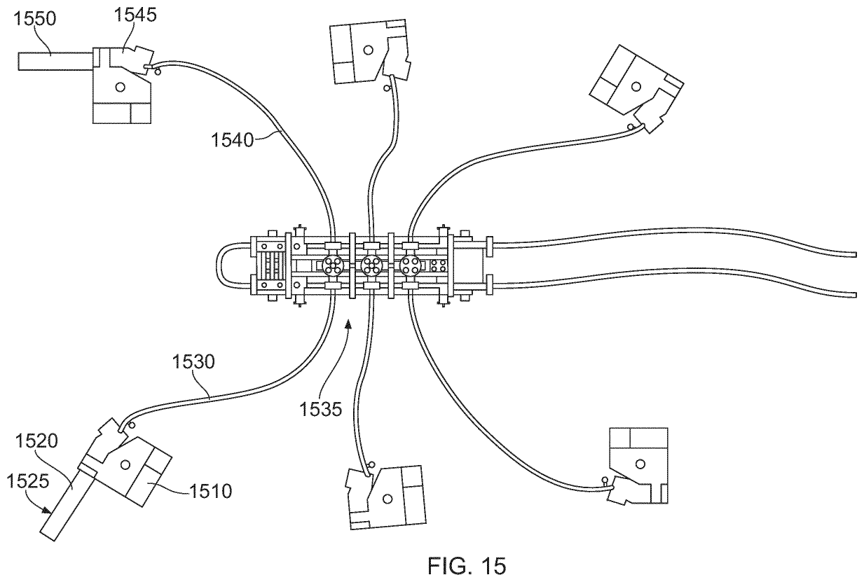

FIG. 15 illustrates an alternative pigging mode of operation in which subsea Christmas Trees, associated jumpers and a manifold valve block can be pigged.

In the drawings like reference numerals refer to like parts.

FIG. 1 illustrates a subsea location 100 located above a well completion 110 that extends from a sub seabed location to the seabed and terminates in a Christmas tree 120. Four subsea Christmas Trees 120 are illustrated in FIG. 1 each connected via a respective jumper 130 to a subsea manifold 140. The manifold 140 is connected via two headers 150, 160 to a lift point 170 and then via respective risers 180, 190 to a floating platform 195. Whilst FIG. 1 shows a floating platform on the surface of the sea it will be appreciated that certain embodiments of the present invention relate to subsea structures able to connect fluid flow pipes able to transport production fluids or other such fluids associated with the oil and gas industry to shore. Likewise it will be appreciated that whilst FIG. 1 illustrates a subsea manifold 140 certain embodiments of the present invention relate to the selection of fluid flow paths at many different types of subsea structure where pigging is needed and multiple inputs should be selectively connected to one or more fluid outlets to separately allow fluid to flow from one location to another or to allow multiple input flows to comingle and thereafter flow out through a common outlet.

FIG. 2 illustrates a plan view from above of the manifold 140 shown in FIG. 1 in more detail. The manifold 140 includes a rigid framework 200 which supports the two headers 150, 160 in a spaced apart substantially parallel configuration. FIG. 2 also helps illustrate two rigid valve block bodies 210_{1,2} which are disposed in a spaced apart relationship substantially parallel across the two underlying headers. The two headers are external to the valve block bodies. Each valve block body is a rigid block of material such as a forged metallic body. This can be made from a single forging which then has internal lumens bored through it or can be 3D printed or made via another type of additive manufacturing process. Other manufacturing techniques and indeed other materials can of course be utilised.

FIG. 2 illustrates how four flow selector valves 220₁ extend from the upper surface of the first valve block body 210₁. Similarly four flow selection valves 220₂ extend outwards (out of the page in FIG. 2) from an upper surface of the second valve block body 210₂. FIG. 2 also helps illustrate how two inlet isolation valves 230₁ are provided for the first (left hand side in FIG. 2) valve block body. Likewise two inlet isolation valves 230₂ extend from an upper surface of the right hand side (shown in FIG. 2) valve block body. FIG. 2 also helps illustrate how a pig path isolation valve 235 is provided for each valve block body. Each isolation valve and each flow selector valve and each pig path isolation valve can be remotely controlled via respective electrical or hydraulic mechanisms to selectively open and close. Each isolation valve 230 can close to prevent fluid flowing from an inlet fluid flowline connected to a respective fluid inlet from flowing into the internal fluid communication passageways in the valve block body. Likewise each flow selection or flow selector valve can selectively close or open to allow fluid to flow along a fluid communication passageway portion provided by a bore internally within the valve block body. Likewise each pig path isolation valve can selectively open or close to permit or prevent pigging of the respective valve block.

FIG. 2 also illustrates how each valve block body includes two outlet blocks 240. The first valve block body 210, shown on the left hand side of FIG. 2 includes a left hand side and a right hand side (in FIG. 2) outlet block 240₁. Likewise the right hand side (in FIG. 2) valve block 210₂ includes a left hand side and right hand side outlet block 240₂. These outlet blocks 240 can be securely bolted to the valve block body 210 in a selected one of four possible orientations whereby an outlet aperture in the outlet block can point downwards (into the page in FIG. 2), upwards (out of the page in FIG. 2) or left and right (up and down in FIG. 2). It will be appreciated that less than four or more than four possible orientation could be utilised if an outlet block is suitably shaped (hexagon or octagon) and provided with suitable securing elements.

FIG. 3a and FIG. 3b illustrate a single rigid valve block body 210 in more detail and illustrate a first fluid inlet 300 which is an opening in an outer surface of the valve block body. A further fluid inlet 310 is illustrated at an opposed end of the rigid valve block body. FIG. 3a and FIG. 3b also helps illustrate how the outlet blocks 240 maybe secured via bolts 320 to the rigid valve block body. Other securing mechanisms could of course be utilised.

FIG. 4 illustrates the passageways formed internally within the rigid valve block body. FIG. 4 thus helps illustrate how the rigid valve block body 210 can be utilised to determine a flow direction at a subsea structure. The valve block body includes a first fluid inlet 300 and a further fluid inlet 310 at opposed ends of the rigid valve block body. A first fluid outlet 400 is an opening in a side of the valve block body. A further fluid outlet 410 is provided by another opening in an outer surface at a remaining side of the valve block body. The first and further fluid outlets are disposed in a spaced apart relationship at opposite sides of the valve block body. A first V-shaped fluid communication passageway 420 extends from a straight inlet passageway portion 425 which leads from the first fluid inlet 300 via a isolation valve chamber 430 to the meeting point where two passageway portions of the V-shaped fluid communication passageway join. That is to say the first V-shaped fluid communication passageway is formed from two passageway portions 432, 434 which meet at a first common root region 436. Fluid entering the first fluid inlet 300 passes along the straight passageway portion 425 to the root region 436. A state of a respective flow selection valve in a respective selection valve chamber 438, 440 dictates whether incoming flow of fluid from the inlet flows turns in one direction or another or both along a respective passageway portion 432, 434.

The further inlet 310, which is a fluid inlet at an opposed end of the rigid valve block body to the first fluid inlet 300, likewise feeds into a straight fluid communication passageway portion 455 which extends via an isolation valve chamber 460 into a root region from which a first fluid communication passageway portion 462 and a further fluid communication passageway portion 464 extend. Each of those fluid communication passageway portions 462, 464 meet at a common root region 466. A state of a flow isolation valve in the isolation valve chamber 460 determines whether fluid provided at the further inlet 310 flows into the valve block body. If fluid flow does flow into the valve block body because the isolation valve is open then fluid will flow down one or both fluid communication passageway portions. Which path is followed is determined by a state of a respective flow selection valve in a respective flow selection valve chamber 468, 470.

FIG. 4 thus illustrates how the rigid valve block body includes a first and a further V-shaped fluid communication passageway. In the rigid valve block body show in FIG. 4 the valve block body has arms which extend away from a central generally square (in plan view) region. An inlet passageway portion extends in one arm from an inlet to the root part of the V-shaped fluid communication passageway thus providing a substantially Y-shaped fluid communication passageway. As illustrated in FIG. 4 the two V-shaped passageways are opposed in the sense that the ends of the passageway portions 432, 434, 462, 464 meet close to respective outlets 400, 410. That is to say an end region of each passageway portion of the first V-shaped fluid communication passageway meets an end region of a respective passageway portion of the further V-shaped fluid communication passageway proximate to a respective fluid outlet.

FIG. 4 helps illustrate that a fluid communication passageway 480 extends between the first root region 436 and the further root region 466. This creates a “straight through” pathway through the valve block body that enables a pig, used during a pigging mode of operation, to pass through and thus clean the valve block body. A pig path isolation valve is located in an associated pig path isolation valve chamber in the valve block body. In normal operation when fluid is flowing from one or more inlets to one or more selected outlets the central passageway is kept closed by selecting a closed state for the pig path isolation valve. In a pigging mode of operation the pig path isolation valve can be selectively opened to permit passage of a pig device from one inlet to another.

FIG. 4 helps illustrate how the outlets 400, 410 are each “capped” by a respective outlet block 240. The outlet block is shown in more detail in FIGS. 5 and 6. As shown in FIG. 5 an outlet block 240 has an exit aperture within a neck 500. The outlet block 240 can be selectively bolted over the aperture in the valve block body 210 in one of four possible orientations pointing the neck and thus the exit orifice up, down, left or right.

FIG. 6 helps illustrate how various valves or sensors may be secured to or be part of the outlet block 240. For example, an actuated valve 610 or manual valve 620 and/or sensor 630 may be secured to the outlet block 240.

Certain embodiments of the present invention thus provide a compact branch block manifold or other such subsea structure which can use a modular approach to customer requirements with pre-engineered manifold branch assemblies that can be grouped together on a set of common headers to meet a specific manifold application. A family group of multi-slot diamond bore blocks of known sizes, pressure ratings and depth ratings can be utilised. These can use a commonality of parts and shared qualification requirements. The rigid valve block body is provided with external headers which can help significantly reduce cost and weight of a manifold.

Flow from a subsea Christmas Tree can enter a manifold branch (or slot) block via a suitable manual or actuated isolation valve. The rigid block has a size such that the inlet connection on the block can be flanged/studded/butt welded or connected via an integral hub/clamp connection depending upon project requirements.

Inboard of an inlet valve the flow direction has the option to progress down multiple internal bores depending upon whether the flow path is blocked by an isolation (manual or actuated) valve. Aptly these bores will meet around 120 to 150° relative to an inlet connection. Aptly the bores meet at around 135° relative to an inlet connection. They direct the flow to desired outlets. Aptly these can be connected to a dual header manifold pipeline system. The outlets merge without flowing from similar back-to-back valve/bore configurations from a second well slot. The merging flows create a diamond bore configuration within the blocks by merging the flows from the well slots in the blocks. This helps reduce the number and complexity of the piping connections made onto the headers. Since the outlets from the blocks are connected directly to headers the outlets provide a further connection point for further pressure and temperature sensors and for chemical injection fluids direct into the headers. This helps simplify header construction when such injection ports are required. Thus, the diamond bore configuration presents an optimal design for use in a dual header manifold or single header manifold with sampling or injection line.

Through using a block construction approach the thermal properties of the blocks can be closely controlled with the option to easily add insulation to slab sides of the blocks. This can be applied for applications when thermal inertia is a critical requirement to the management of the produced fluids during well intervention or an unplanned shut-in event.

A block includes back-to-back well connection slots with each block design including two off well slots. Produced fluid enters the block through a suitable connection outboard of the well isolation valve. The flow path then splits into two-off flow bores arranged at around 135° to the inlet flow path. The produced fluid can then be directed through one of the flow bores through a selection valve to an outlet located on either side of the block. Alternatively, as described hereinafter flow can flow to a central fluid exit/outlet located within the middle of the block for four-slot or six-slot variants. Due to the nature of the back-to-back well slot configuration the bores create a diamond pattern internally within the blocks. The bores meet at the outlet at an angle of 90° or 180° relative to each other. This helps maintain a cross sectional area within the flow paths the outer intercepting bores are counter sunk relative to the face of the blocks.

Mounted to the side of the main (or primary) valve block bodies are side blocks (also referred to as outlet blocks or end blocks) for collecting and directing flow towards headers. These side blocks are held on with four-off sets of studs and nuts. This helps allow the side blocks to be rotated through increments of 90° relative to the main block to direct the flow towards a preferred location within a manifold. This helps simplify a piping arrangement and reduces a number of wells (and thus potential leak paths) required in any interconnecting pipe work.

FIG. 7 illustrates an alternative valve block body 710. The valve block body illustrated in FIG. 7 includes a first fluid inlet 700 and a further fluid inlet 710. The inlets are formed in a valve block body 715. As illustrated in FIG. 7 the bores or passageways through the valve block body shown in FIG. 7 do not have a common internal bore diameter. That is to say a central through bore 720 which is usable during a pigging mode of operation has a cross section 725 which is greater than a corresponding cross section 730 in the passageway portions that lead from a root region to an outlet of the valve block body. The inner bore diameter 725 of the main through bore which is piggable illustrated in FIG. 7 has an internal diameter of around 240 mm to 280 mm. Aptly as an alternative the inner bore diameter may be around 200 mm to 400 mm. By contrast the internal bore diameter 730 in the passageway portions leading to the outlets has an internal bore diameter of around 110 mm to 150 mm. Aptly as an alternative the inner bore diameter of the side passageway portions which are not piggable could be around 90 mm to 230 mm.

FIG. 7 helps illustrate how a pig may be prevented from accidentally routing down an undesired passageway in the valve block body. It will be appreciated that a pig device having a pre-set outer diameter is selected according to the bore through the main valve block body that is to be pigged along with any jumpers and/or subsea Christmas Trees cleaned during a pigging mode of operation. Because the side passageways of the V-shaped fluid communication passageways have a smaller diameter the pig is prevented from routing by accident down an undesired passageway portion that would lead to an outlet (which is not pigged). Aptly the inner bore diameter of each passageway portion leading to or from an outlet of the valve block body is less than 70% and optionally less than 50% of a corresponding inner bore diameter of the inlet connecting fluid communication passageway which passes straight through the valve block body and which is piggable.

FIG. 8 illustrates an alternative valve block body. A first fluid inlet 800 and a further fluid inlet 810 are disposed on opposed ends of the valve block body 815. The inner bore diameter of the through bore which connects the first fluid inlet 800 to the further fluid inlet 810 and which thus constitutes an inlet connecting fluid communication passageway that extends between a first common root region and a further common root region has a similar bore size to the passageway portions which are part of a V-shaped fluid communication passageway leading from root regions to respective outlets. FIG. 8 illustrates how an insert 840 can be utilised at a common root region 845 to prevent a pig passing between the first fluid inlet 800 and the further fluid inlet 810 from accidentally getting trapped or deviating along an undesired pathway.

FIG. 9 illustrates an insert 840 shown in FIG. 8 in more detail. FIG. 9 helps illustrate how the insert is a generally cylindrical sleeve body 900 having a first open mouth 910 and a further open mouth 920 at a remaining end of the sleeve 900. The outer diameter of the insert has a diameter which substantially matches the inner diameter of the through bore that passes through the valve block body and which provides the inlet connecting fluid communication passageway. The sleeve 900 has a relatively slim thickness. The sleeve illustrated in FIG. 9 has a thickness of around 20 mm to 60 mm. In use the sleeve is aligned substantially along the inlet connecting fluid communication passageway and presents a substantially open bore which thus has little fluid restraining capability. That is to say fluid flows readily in a more or less unrestrained fashion along the central bore with the sleeve in use.

FIG. 9 helps illustrate how one or more openings 930 are formed in the sleeve body. In FIG. 9 and the insert shown in FIG. 9 each through opening in the sleeve body is an elongate slit. Four slits are illustrated on one side of the sleeve 900 and another four slits are shown on another side of the sleeve generally diametrically opposite to the first side. The through holes formed as slits in the sleeve body allow for fluid to flow from the region inside the sleeve into a side passageway portion leading to a fluid outlet. By contrast the parts of the body of the sleeve which remains between slits each effectively provide a pig prevention member 940.

FIG. 10 illustrates another view of the insert 840 illustrated in FIGS. 8 and 9. FIG. 10 helps illustrate how the edges of the openings 930 on each side of the sleeve have edges that fall on an imaginary circle 1000 when viewed from a position along an axis of a side passageway portion. That is to say from the perspective of fluid flow in a passageway portion between a root region and an outlet of the valve block body the openings in the sleeve project a substantially open pathway. Nevertheless parts of the sleeve which do not have through holes formed in them act as pig prevention members preventing a pig passing through the central bore in the valve body from accidentally routing down a side passageway portion.

FIG. 11 illustrates an alternative insert in a valve block body. As illustrated in FIG. 11 a first fluid inlet 1100 is connected to a further fluid inlet 1110 on opposed ends of a valve block body 1115. An insert 1140 is duly located at a common root region from which side passageway portions extend to respective outlets formed in the valve block body. FIG. 12 helps illustrate the insert 1140 shown in FIG. 11 in more detail. This insert has a first plurality of through holes 1210 on one side of a sleeve-like body 1215 and a further plurality of through holes 1220 formed in the sleeve body generally diametrically opposed to the first plurality of through holes. In FIG. 12 the clusters of through holes are shown as including four large diameter circular through holes and six small diameter circular through holes. That configuration and clustering is repeated on the diametrically opposed side of the sleeve. Each through hole in the plurality of through holes in the sleeve-like body of the insert thus comprises a round aperture. Each plurality of through holes comprises one, two or three small diameter holes (two shown in FIG. 12) disposed between two spaced apart large diameter holes aligned along a common major alignment axis 1230. Two further larger diameter holes are aligned on a centre point 1240 associated with the small diameter holes between the two large holes on the common major alignment axis and these two further larger diameter holes are perpendicular to the common major alignment axis when viewed in plan view side on to a sleeve body. Each of the groups or clusters of through holes includes at least one further pair of small diameter holes each small hole in a pair of small diameter holes being aligned on a respective side of a respective further larger diameter hole along a minor alignment axis 1250 which is spaced apart from and substantially parallel to the major alignment axis 1230. Each small diameter hole is a round hole having a diameter of between around 50 mm and 90 mm. In FIG. 12 each small diameter hole has an internal diameter of around 15 mm to 30 mm. Each large diameter hole is a round hole that has a diameter of between around 100 mm and 200 mm. In FIG. 12 each large diameter hole has a diameter of around 50 mm to 110 mm. Optionally a diameter of each large hole is less than 25% of the circumference of the sleeve body shown in FIG. 12. The insert 1140 shown in FIG. 12 allows fluid to flow more or less unrestrained along the central through bore in the valve block body that forms the inlet connecting fluid communication passageway. The insert likewise provides a relatively open pathway for fluid to flow from the common root region where the insert is located to an outlet. Nevertheless the material of the sleeve-like body of the insert between the round holes acts to prevent movement of a pig device used in a pigging mode of operation to pass along the inlet connecting fluid communication passageway to accidentally move along one of the side passageway portions towards a fluid outlet. It will be appreciated that alternative numbers and configurations of circular throughholes might be utilised and that the material of the sleeve like body that forms the insert provides one of more pig blocking member/s accordingly.

In the embodiments previously described the valve block body may be made from a solid low alloy steel forging. A central through bore that connects root regions may be machined by drilling/milling and may optionally receive a welded layer of corrosion resistant alloy. Aptly the corrosion resistant material can be Inconel or the like.

Optionally an insert body such as those illustrated in FIG. 8 or 11 is made from a solid corrosion resistant block. Aptly this is an Inconel or super duplex or the like material. After the insert has been machined it is positioned inside the valve block with respective openings such as slits or round through holes aligned with respective side bores. The insert can then be secured in place via a welding operation

FIG. 13 illustrates a subsea manifold secured to six subsea Christmas Trees via respective jumpers. As illustrated in FIG. 13 each subsea Christmas Tree 1320 is connected via a respective jumper 1330 to the manifold. The manifold shown in FIG. 13 includes three valve block bodies of the type previously described. The manifold is connected to two headers 150, 160 which transport fluid towards a target location. During use the Christmas Trees selectively provide fluid to fluid inlets of respective valve block bodies and fluid flow can be selected by actuating selection valves to connect the fluid to the headers.

FIG. 14 illustrates how a pigging mode of operation can be carried out on the subsea Christmas Trees and manifold valve blocks illustrated in FIG. 13. As illustrated in FIG. 14 when the subsea Christmas trees are not themselves piggable each respective jumper 1330 is first disconnected from a Christmas Tree and then a pig launcher 1400 can be connected to an end 1410 of a respective jumper 1330. Likewise a further pig launcher/receiver 1430 is connected to a further jumper 1330 on opposed sides of a manifold valve block body. A conventional pigging technique can then be utilised to urge a pig device 1440 along the connected jumper 1330 into an inlet of the first (left hand side in FIG. 14) manifold valve block body. The pig pathway isolation valve is by this stage open enabling the pig device 1440 to pass through the valve block body through the remaining inlet at an opposed end of the manifold valve block body and that pig can pass through into the further jumper on its way to the opposed pig launcher unit 1430. In this way during a pigging mode of operation two jumpers and a respective manifold valve block body can be pigged. Subsequent to pigging the two branch lines provided by respective jumpers, the jumpers can thereafter be reconnected to their respective subsea Christmas Trees for further normal operation. The pig launchers can thereafter be utilised to pig out the remaining branch lines by disconnecting respective Christmas Trees first and then pigging through jumpers and manifold valve block body during a pigging mode of operation.

FIG. 15 shows an alternative pigging mode of operation in which the Christmas trees themselves are piggable. As illustrated in FIG. 15 a piggable Christmas Tree 1510 is connected to a pig launcher 1520. The pig launcher can launch a pig 1525 through the piggable subsea Christmas tree 1510 into a respective jumper 1530. During the pigging mode of operation the pig passes through the jumper into a respective manifold valve block body 1535 which has had a pig pathway isolation valve opened. This enables the pig device 1525 to pass all the way through the valve block body and out through a remaining jumper 1540 which is connected to a further piggable subsea Christmas tree 1545. A further pig launcher unit 1550 is connected to the piggable subsea Christmas tree 1545 during a pigging mode of operation. After pigging is completed a respective pig path isolation valve is closed.

According to certain embodiments of the present invention valve blocks can be sized/optimised for a specific valve bore size and pressure rating. As a result a family group of block configurations can be developed to meet a range of subsea Christmas tree sizes and pressure ratings. Valves within any block can be suitably placed so as to not only account for a change of actuation method but also for any impact of water depth on actuator size requirements.

Certain embodiments of the present invention provide better thermal performance, thereby reducing insulation requirements. Through using a block construction approach the thermal properties of the blocks can be closely controlled with an option to easily add insulation to slab sides of the blocks. This can be achieved for applications when thermal inertia is an important requirement for the management of the produced fluids during well intervention or an unplanned shut-in event.

Since produced fluid flows are merged at block outlets a number of connections required onto headers is immediately reduced resulting in a simplified pipework with minimised welding and non-destructive examination requirements. This inherent reduction of field weld connections automatically helps simplify a manifold assembly and testing process and requirements. This potentially speeds up assembly and testing processes and reduces a need for complicated fabrication jigs.

Through using blocks of known size and dimensions with pre-defined interface locations a manifold structure can be modularised with dedicated structural interfaces to blocks (namely, for guide supports or anchor supports) and to integrated ROV panels. This helps speed up a project design process with reduced risk of omissions/errors in a complete manifold assembly.

Where appropriate, according to certain embodiments of the present invention blocks can be machined to provide an integral mini-manifold for any sea-chest compensation circuits required for actuators and to provide anchoring points for associated small-bore piping. As a result the blocks can also help simplify the small-bore piping required upon a manifold system.

Throughout the description and claims of this specification, the words “comprise” and “contain” and variations of them mean “including but not limited to” and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of the features and/or steps are mutually exclusive. The invention is not restricted to any details of any foregoing embodiments. The invention extends to any novel one, or novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A rigid valve block body for determining fluid flow direction at a subsea structure, comprising:
a first fluid inlet and a further fluid inlet at opposed end regions of a rigid valve block body;
a first fluid outlet of the valve block body and a further fluid outlet of the valve block body disposed in a spaced apart relationship;
a first V-shaped fluid communication passageway that comprises two passageway portions each extending within the valve block body from a first common root region proximate to the first fluid inlet;
a further V-shaped fluid communication passageway that comprises two further passageway portions each extending within the valve block body away from a further common root region proximate to the further fluid port, wherein an end region of each passageway portion of the first V-shaped fluid communication passageway meets an end region of a respective passageway portion of the further V-shaped fluid communication passageway proximate to a respective fluid outlet of the valve block body; and
an inlet connecting fluid communication passageway that extends between the first common root region and the further common root region.

2. The valve block body as claimed in claim 1, further comprising:
an inner bore diameter of each passageway portion that is less than a corresponding inner bore diameter of the inlet connecting fluid communication passageway.

3. The valve block body as claimed in claim 2, further comprising:
the inner bore diameter of each passageway portion being less than 70%, and optionally less than 50%, of a corresponding inner bore diameter of the inlet connecting fluid communication passageway.

4. The valve block body as claimed in claim 1, further comprising:
at least one insert element, each located at a respective common root region, that comprises a sleeve body having an open mouth at each respective sleeve body end and at least one through hole in a sidewall of the sleeve body.

5. The valve block body as claimed in claim 4, further comprising:
the at least one through hole comprising a first plurality of through holes and a further plurality of through holes disposed on diametrically opposed regions of the sleeve body.

6. The valve block body as claimed in claim 5, further comprising:
each through hole in each plurality of through holes comprising an elongate channel.

7. The valve block body as claimed in claim 6, further comprising:
each elongate channel configured so that, when viewed from a side at an angle common to an offset angle between each passageway portion and the inlet connecting fluid communication passageway, an outline edge region of each channel falls on an imaginary circle.

8. The valve block body as claimed in claim 5, further comprising:
each through hole in each plurality of through holes comprising a round aperture.

9. The valve block body as claimed in claim 8, further comprising:
each plurality of through holes comprising one, two or three small diameter holes disposed between two spaced apart large diameter holes aligned along a common major alignment axis and two further larger diameter holes each aligned on a center point associated with the small diameter holes and perpendicular to and on respective opposed sides of the common major alignment axis.

10. The valve block body as claimed in claim 9, further comprising:
each plurality of through holes comprising at least one further pair of small diameter holes each small hole in a further pair of small diameter holes being aligned on a respective side of a respective further large diameter hole along a minor alignment axis that is spaced apart from and substantially parallel with the major alignment axis.

11. A method of providing a rigid valve block body, comprising the steps of:
providing a valve block body blank;
providing a first lumen through the blank from a first fluid inlet at a first blank end to a further fluid inlet at a further blank end;
providing a second lumen and a third lumen as respective passageway portions from a first fluid outlet on a first blank side to a respective one of a first common root region and a further common root region in fluid communication with the first lumen; and
providing a fourth lumen and a fifth lumen, as respective passageway portions, from a further fluid outlet on a further blank side to a respective one of the first common root region and the further common root region.

12. The method as claimed in claim 11, further comprising:
providing the first lumen, as an inlet connecting fluid communication passageway, with an inner bore diameter that is greater than a corresponding innerbore diameter of each passageway portion and optionally providing the first lumen as a straight through bore in the blank or as a through bore that is curved with a radius of curvature greater than 2 m.

13. The method as claimed in claim 12, further comprising:
providing at least one insert element that comprises a sleeve body associated with a longitudinal sleeve access, at a respective common root region;
aligning a respective open mouth at each respective sleeve body end with a primary axis of the first lumen; and
aligning at least one through hole in a sidewall of the sleeve body with a flow axis associated with a respective passageway portion.

14. A method of pigging a manifold valve block body, comprising:
providing a pig device at a first fluid inlet of a first and a further fluid inlet disposed at opposed end regions of a valve block body that comprises a first V-shaped fluid communication passageway that comprises two passageway portions each extending within the valve block body from a first common root region proximate to the first fluid inlet, and a further V-shaped fluid communication shaped passageway that comprises two further passageway portions each extending within the valve block body away from a further common root region proximate to a further fluid inlet;
urging the pig device from the first fluid inlet to a remaining fluid inlet via an inlet connecting fluid communication passageway that extends between the first common root region and the further common root region.

15. The method as claimed in claim 14, further comprising:
preventing the pig device from deviating from a path aligned with the inlet connecting fluid communication passageway.

16. The method as claimed in claim 15, further comprising:
preventing the pig device from deviating by providing the passageway portions as bores in the valve block body that have an inner bore diameter less than an inner bore diameter of the inlet connecting fluid communicating passageway.

17. The method as claimed in claim 15, further comprising:
preventing the pig device from deviating via at least pig blocking member of at least one insert element provided at a respective common root region in the valve block body.

18. The method as claimed in claim 17, further comprising:
providing fluid communication between a common root region and a passageway portion that extends from the common root region, via a plurality of through holes in a sleeve body of the insert element; and
preventing passage of the pig device along said passageway portion via a portion of the sleeve body disposed between adjacent through holes.

19. A method for determining fluid flow direction at a subsea structure, comprising the steps of:
providing an incoming flow of fluid to at least one fluid inlet of a plurality of fluid inlets of a valve block body; and
selecting a state of a respective isolation valve in a flow path of each of two respective passageway portions, of at least one V-shaped fluid communication passageway of at least two V-shaped fluid communication passageways in the valve block body; and
selecting a closed state of a pig path isolation valve to prevent fluid flow along an inlet connecting fluid communication passageway between a first and further fluid inlet of the valve block body; thereby
directing the incoming flow of fluid from the at least one fluid inlet to a selected one fluid outlet of the valve block body.

20. The method as claimed in claim 19, further comprising:
simultaneously providing an incoming flow of fluid at a plurality of the fluid inlets; and via a selected state of the isolation valves in the V-shaped fluid communication passageways, and with the pig path isolation valve in a closed state, routing the incoming flow along a plurality of passageway portions to a common outlet thereby mingling fluid from a plurality of sources or to separate fluid outlets thereby keeping fluid from a plurality of sources separate as the fluid flows through the valve block body.
